(19) United States
(12) Patent Application Publication
(10) Pub. No.: US 2019/0328602 A1
(43) Pub. Date: Oct. 31, 2019

(54) Burial Capsule with an Interlocking Lid

(71) Applicant: Willie D. Mullins, New Paris, OH (US)

(72) Inventor: Willie D. Mullins, New Paris, OH (US)

(21) Appl. No.: 16/399,201

(22) Filed: Apr. 30, 2019

Related U.S. Application Data
(63) Continuation-in-part of application No. 29/645,918, filed on Apr. 30, 2018.
(60) Provisional application No. 62/664,607, filed on Apr. 30, 2018.

(51) Int. Cl. A61G 17/02

(52) U.S. Cl. CPC A61G 17/024; A61G 17/036

(57) ABSTRACT

A burial capsule with an interlocking lid is designed to enable a user to view the body of a deceased individual in unique configurations. To achieve this, the burial capsule has a base receptacle, a lofted lid, an interlocking rail assembly, and a cap. An interior compartment of the base receptacle is used to store the body of the deceased. Additionally, the interlocking rail assembly has a set of rails that are mounted in between the base receptacle and the lofted lid. Specifically, a pair of interlocking rails are mounted onto the base receptacle and a corresponding pair of interlocking rails are mounted onto the lofted lid. The rails are designed to form an interlocking connection that enables the lid to be slidably mounted onto the base receptacle. The cap and lid work in concert to seal the interior compartment of the base receptacle.

The current application claims a priority to the U.S. Provisional Patent application Ser. No. 62/664,607 filed on Apr. 30, 2018.

### FIELD OF THE INVENTION

The present invention generally relates to caskets. More specifically the present invention is a capsule with an integrated lid that allows for various viewing configurations during ceremonies.

### BACKGROUND OF THE INVENTION

Caskets and burial coffins are commonly used to shelter the remains of deceased individuals. These storage assemblies are designed to provide a space where the lifeless body can be kept in a respectful manner, prior to, and after the burial. Funeral procedures vary depending on various factors including traditions and cultural norms. Most coffins are designed using the same basic principles. Traditionally they include a rectangular structure with a lid, however it is not uncommon for people to customize the caskets with various features and ornamental elements. As such coffins of various complexity can be designed. Practical elements such as handles, and other mechanism that facilitate lowering the casket into the ground may also be added, while other devices improve viewing ceremonies prior to burial.

Family members and loved ones often wish to pay final respects to the deceased prior to burial. As such a viewing ceremony is organized where the individual is placed within the coffin with the lid opened. In some cases, a ceremony with a closed casket may be more suitable depending on the cause of death or preference. The present invention aims to solve some of the problems discussed above by disclosing a casket with an integrated sliding lid that may be opened or closed in a secured manner. In addition, the lid may be removed altogether if additional space is required to position the body in the casket.

The present invention is a modular burial capsule. The burial capsule comprises a base assembly and a lid assembly. In the current embodiment the burial capsule has a rectangular profile with rounded edges, however the present invention is not limited to this option. The main body may be further designed in a plurality of other shapes, without departing from the scope of the invention. The combination of components allows for an improved method of keeping the remains of a deceased person prior and during funeral proceedings. The base assembly further comprises a base compartment, a base insert, a base rail, a cap and a pad, however the present invention is not limited to this option. The base compartment further comprises a plurality of handles. The plurality of handles allows users to easily transport the present invention. A plurality of grips may also be inserted into the cavity of the plurality of handles to ensure the user is able to secure an adequate grasp on the casket during transport. Currently the present invention comprises a total of six handles, three on each side of the base assembly. The plurality of handles is positioned along the peripheral length of the base assembly. Each handle is spaced equidistantly in reference to the outer edges of the base compartment.

The base insert is positioned on top of the base compartment. The base insert further comprises a flat top, and a plurality of sidewall reinforcements. The base rail is positioned on top of the base insert, allowing the user to operate the sliding mechanism between the base assembly and the lid assembly. Furthermore, the pad is positioned on the interior cavity of the base compartment. Various materials types of pads and materials may be used in the present invention, depending on user preference and application. In another embodiment, the pad may be removed altogether. The cap is attached at one end of the base compartment. The cap resembles the shape of the lid assembly, and in the current embodiment it is permanently attached to the base compartment using adhesive, however the present invention is not limited to this option.

The lid assembly further comprises a lid cover, a lid reinforcement, a lid receiving rail, and a locking mechanism. The lid reinforcement is inserted into the lid cover, with the lid receiving rail positioned on top of the lid reinforcement. The lid receiving rail, linearly slides over the base rail, securing the lid assembly to the base assembly and the cap. The lid receiving rail further comprises a slot integrated into the design that allows the matching base rail to slide over the lid receiving rail. The locking mechanism is integrated into the lid cover. In the preferred embodiment the locking mechanism is positioned at the short end of the lid cover, however the present invention is not limited to this option. Furthermore, various types of locks may be used to secure the lid assembly to the base assembly. Presently, the lid cover comprises a flat top, and a plurality of rounded edges, however the present invention is not limited to this option and as such, various features and design elements may be further integrated into the lid cover. The present invention allows users to customize the overall design of the lid assembly. An important feature that is at the centerpiece of the present invention is the lightweight construction, and in the current embodiment the present invention is constructed out of fiberglass, however other materials and manufacturing methods may be used during fabrication. Lightweight durable materials including but not limited to, biodegradable polycarbonates may be used as an alternative.

### BRIEF DESCRIPTION OF THE DRAWINGS

FIG. 1 is a perspective view of the present invention.

FIG. 2 is a perspective view of the present invention with the lofted lid detached from the base receptacle.

FIG. 3 is a perspective view of the base receptacle and padded liner used in the present invention.

FIG. 4 is an exploded perspective view of the present invention.

FIG. 5 is an exploded right-side view of the present invention.

FIG. 6 is a sectional view of the present invention taken along line 6-6 in FIG. 5.

### DETAIL DESCRIPTIONS OF THE INVENTION

All illustrations of the drawings are for the purpose of describing selected versions of the present invention and are not intended to limit the scope of the present invention.

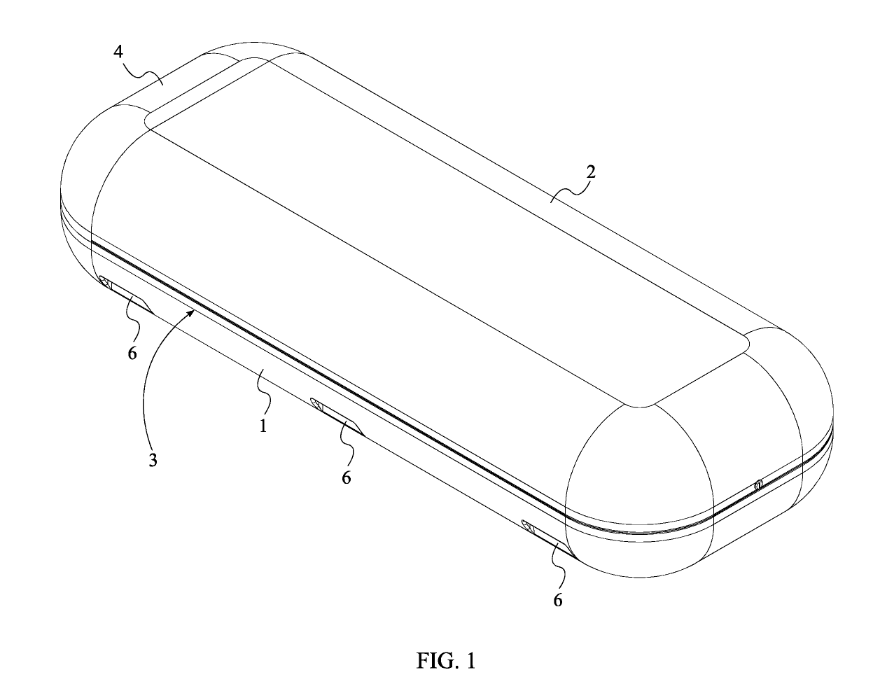

In reference to FIG. 1 through FIG. 6, the present invention, the burial capsule with an interlocking lid, is a casket that has a removable lid which can be used to selectively show the body of deceased person. The present invention achieves this functionality by making use of a sliding connection system between the casket's base and lid. Specifically, the present invention comprises a base receptacle 1, a lofted lid 2, an interlocking rail assembly 3, and a cap 4. the base receptacle 1 forms the bottom half of the casket and is used to store the body of the deceased individual. As such, the base receptacle 1 comprises a receptacle body 11 and an interior compartment 12 that traverses into the receptacle body 11. The interlocking rail assembly 3 is a mounting system that enables the lofted lid 2 to be slidably mounted over the base receptacle 1. Additionally, the interlocking rail assembly 3 comprises at least one first base rail 31, at least one second base rail 32, at least one first lid rail 33, and at least one second lid rail 34. The first base rail 31 is mounted along a first lengthwise edge 13 of the base receptacle 1 and the second base rail 32 is mounted along a second lengthwise edge 14 of the base receptacle 1. Similarly, the first lid rail 33 is mounted along a first lengthwise edge 13 of the lofted lid 2 and the second lid rail 34 is mounted along a second lengthwise edge 14 of the lofted lid 2. Additionally, the first lid rail 33 is slidably engaged along the first base rail 31 and the second lid rail 34 is slidably engaged along the second base rail 32. As a result, the lofted lid 2 is slidably mounted onto the base receptacle 1 and positioned over a portion of the interior compartment 12. Further, the first base rail 31 the first lid rail 33, the second base rail 32 and the second lid rail 34 govern the path along which the lofted lid 2 travels when sealing or unsealing the interior compartment 12. The cap 4 is an additional component that enables a user to reveal a portion of the body of the deceased individual without removing the lid. To achieve this functionality, the cap 4 is detachably mounted onto the base receptacle 1. Additionally, the cap 4 is positioned adjacent to the first base rail 31 and the second base rail 32. Consequently, the cap 4 and the lofted lid 2 form a covering that is used to seal the interior compartment 12. Further, because the cap 4 is positioned over a portion of the interior compartment 12, the user is able to reveal a portion of the body of the deceased without moving the lofted lid 2.

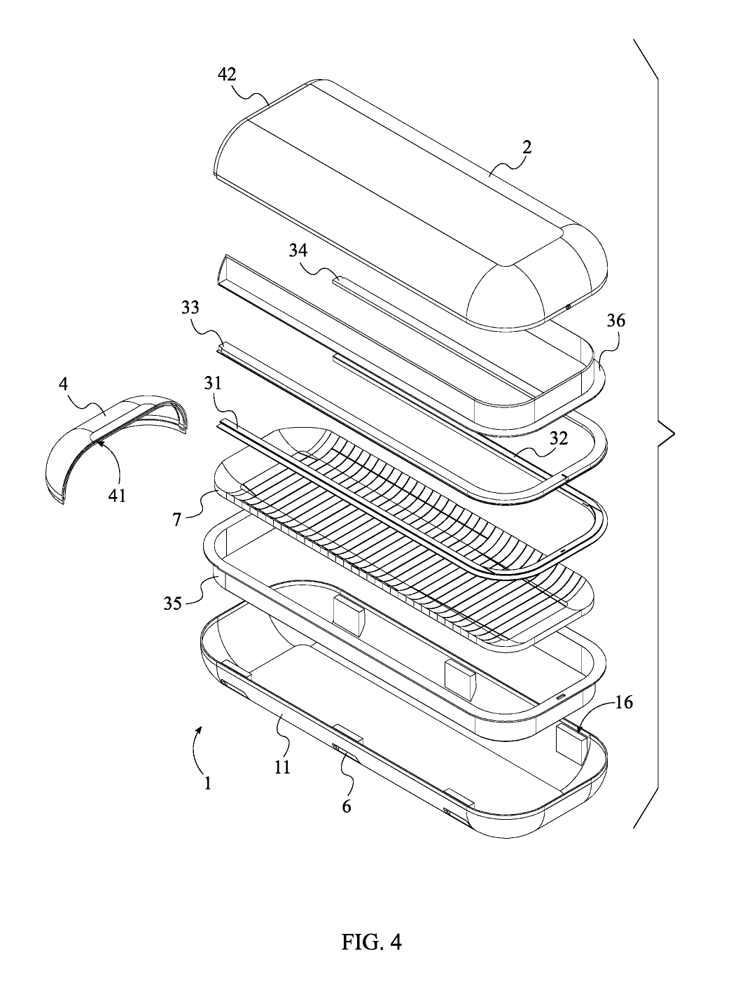

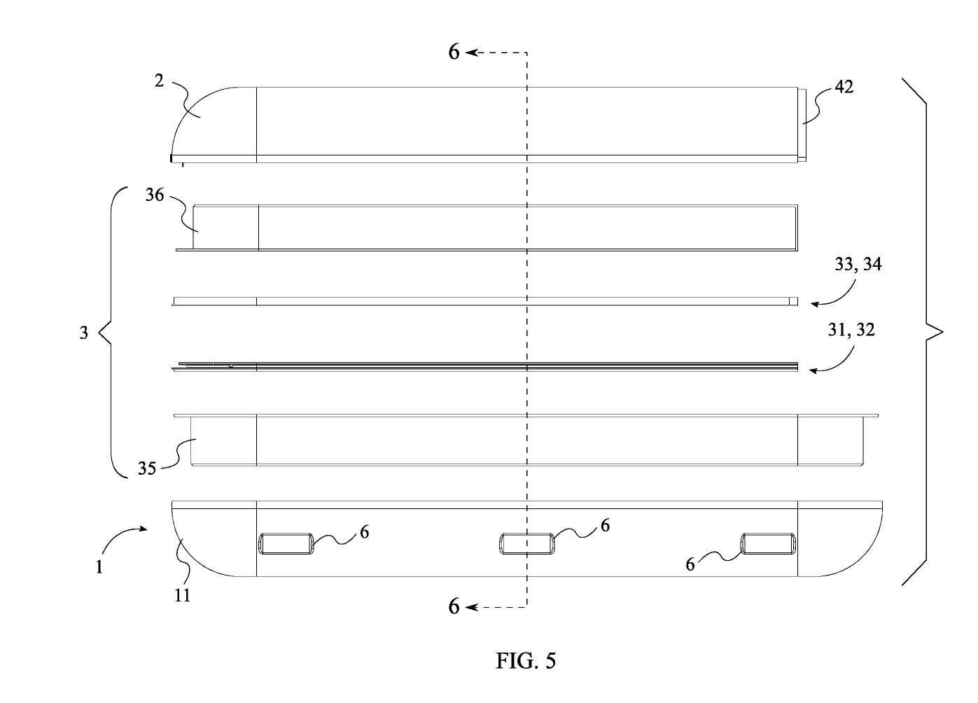

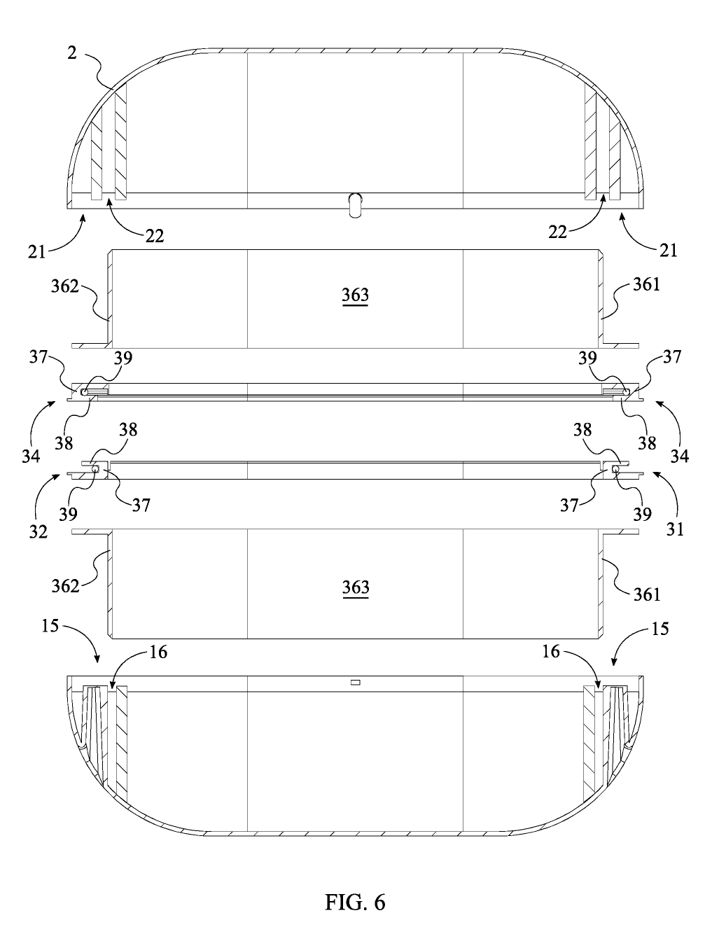

In reference to FIG. 4, FIG. 5, and FIG. 6, preferably, the interlocking rail assembly 3 is designed to function as a mounting system that enables the lofted lid 2 to be attached or removed from the base receptacle 1 with minimal effort. To that end, the interlocking rail assembly 3 further comprises a base support member 35 and a lid support member 36. The base support member 35 and the lid support member 36 are rigid mounting platforms that enable the rails of the interlocking rail assembly 3 to remain functional even when buried or exposed to the elements. To that end, the base support member 35 and the lid support member 36 each comprise a first leg 361, a second leg 362, and an intermediary leg 363. Specifically, the intermediary leg 363 is terminally connected in between the first leg 361 and the second leg 362. Thus configured, the base support member 35 and the lid support member 36 form U-shaped supports that are positioned coextensive with 3 sides of the coffin. Specifically, the base support member 35 is mounted onto a rim 15 of the base receptacle 1. likewise, the lid support member 36 is mounted onto a rim 21 of the lofted lid 2. As a result, the base support member 35 and the lid support member 36 form mounting structures that are positioned in between the receptacle body 11 and the lofted lid 2. Preferably a cap mounting beam is connected in between the first leg 361 of the base support member 35 and the second leg 362 of the base support member 35. Thus positioned, the cap mounting beam, the first leg 361 of the base support member 35, the second leg 362 of the base support member 35 and the intermediary leg 363 of the base support member 35 form an annular frame capable of supporting the interlocking rail assembly 3 and the cap 4. The first base rail 31 is mounted onto the first leg 361 of the base support member 35, opposite to the base receptacle 1. Likewise, the second base rail 32 is mounted onto the second leg 362 of the base support member 35, opposite to the base receptacle 1. Consequently, the first base rail 31 and the second base rail 32 are maintained in orientations parallel to the first lengthwise edge of the base receptacle 1 and the second lengthwise edge of the base receptacle 1, respectively. The first lid rail 33 is mounted onto the first leg 361 of the lid support member 36, opposite to the lofted lid 2. likewise, the second lid rail 34 is mounted onto the second leg 362 of the lid support member 36, opposite to the lofted lid 2. As a result, the first lid rail 33 and the second lid rail 34 are maintained in orientations parallel to the first lengthwise edge of the lofted lid 2 and the second lengthwise edge of the lofted lid 2, respectively. Consequently, the base support member 35 and the lid support member 36 retain the first base rail 31, the second base rail 32, the first lid rail 33, and the second lid rail 34 in orientations that facilitate forming a slidable connection between the receptacle body 11 and the lofted lid 2.

In reference to FIG. 4 and FIG. 6, the interlocking rail assembly 3 is designed to be a modular component that is detachably mounted in between the base receptacle 1 and the lofted lid 2. To achieve this functionality, the base receptacle 1 further comprises a first retention groove 16. Additionally, the present invention further comprises a second retention groove 22. The first retention groove 16 is an annular trench that traverses into the rim 15 of the base receptacle 1. Thus positioned, the first retention groove 16 runs around the rim 15 of the base receptacle 1. The base support member 35 is engaged within the first retention groove 16. As a result, the base support member 35 can be securely mounted to the receptacle body 11 without the use of adhesives or permanent bonds. Preferably, a plurality of detachable fasteners is distributed around the first retention groove 16 so that a disengageable connection can be established between the base receptacle 1 and the interlocking rail assembly 3. In a similar manner, the second retention groove 22 is a U-shaped trench that traverses into the rim 21 of the lofted lid 2. Thus positioned, the second retention groove 22 runs along and between the first lengthwise edge of the lofted lid 2 and the second lengthwise edge of the lofted lid 2. The lid support member 36 is engaged within the second retention groove 22. As a result, the lid support member 36 can be securely mounted to the lofted lid 2 without the use of adhesives or permanent bonds. Preferably, a plurality of detachable fasteners is distributed around the second retention groove 22 so that a disengageable connection can be established between the lofted lid 2 and the interlocking rail assembly 3. The base support member 35 and the lid support member 36 are designed to facilitate opening and closing the lofted lid 2. To that end, the base support member 35 and the lid support member 36 each comprise an alignment lip 5. The alignment lip 5 is mounted onto the intermediary leg 363 and positioned offset from the first leg 361 and the second leg 362. Accordingly, the alignment lip 5 forms a stop member that limits the distance the lofted lid 2 is able to slide along the interlocking rail assembly 3 when sealing the interior compartment 12. The positioning of the alignment lip 5 forms a gap that enables the first lid rail 33 to slide along the first base rail 31 and the second lid rail 34 to slide along the second base rail 32 when sealing the interior compartment 12.

In reference to FIG. 4, FIG. 5, and FIG. 6, the lid is designed to hermetically seal the interior compartment 12 when mounted onto the base receptacle 1. To facilitate this the first base rail 31, the second base rail 32, the first lid rail 33, and the second lid rail 34 are constructed as interlocking brackets. Specifically, the first base rail 31, the second base rail 32, the first lid rail 33, and the second lid rail 34 each comprise a first rail leg 37, a second rail leg 38, and a seal 39. That is, each rail on the base support member 35 is formed into an L-shaped bracket that interlocks with a corresponding rail on the lid support member 36. The first rail leg 37 of the first base rail 31 is mounted in between the base receptacle 1 and the second rail leg 38 of the first base rail 31. Accordingly, the first rail leg 37 of the first base rail 31 is the interconnecting beam that holds the second rail leg 38 of the first base rail 31 parallel to and offset from the base support member 35. The seal 39 of the first base rail 31 is mounted adjacent to the first leg 361 of the first base rail 31 so that the first base rail 31 facilitates the formation of a hermetic seal. Similarly, the first rail leg 37 of the second base rail 32 is mounted in between the base receptacle 1 and the second rail leg 38 of the second base rail 32. Accordingly, the first rail leg 37 of the second base rail 32 is the interconnecting beam that holds the second rail leg 38 of the second base rail 32 parallel to and offset from the base support member 35. The seal 39 of the second base rail 32 is mounted adjacent to the first leg 361 of the second base rail 32 so that the second base rail 32 facilitates the formation of a hermetic seal. The first rail leg 37 of the first lid rail 33 is mounted in between the lofted lid 2 and the second rail leg 38 of the first lid rail 33. Accordingly, the first rail leg 37 of the first lid rail 33 is the interconnecting beam that holds the second rail leg 38 of the first lid rail 33 parallel to and offset from the lid support member 36. The seal 39 of the first lid rail 33 is mounted adjacent to the first leg 361 of the first lid rail 33 so that the first lid rail 33 facilitates the formation of a hermetic seal. Similarly, the first rail leg 37 of the second lid rail 34 is mounted in between the lofted lid 2 and the second rail leg 38 of the second lid rail 34. Accordingly, the first rail leg 37 of the second lid rail 34 is the interconnecting beam that holds the second rail leg 38 of the second lid rail 34 parallel to and offset from the lid support member 36. The seal 39 of the second lid rail 34 is mounted adjacent to the first leg 361 of the second lid rail 34 so that the second lid rail 34 facilitates the formation of a hermetic seal.

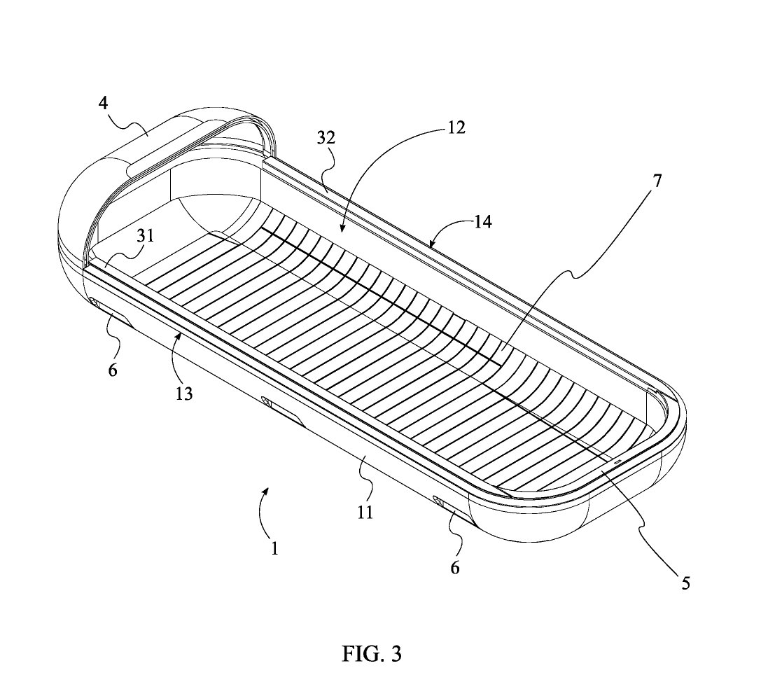

In reference to FIG. 1 and FIG. 3, The present invention is designed to incorporate quality of live features. Specifically, the present invention comprises a plurality of handles 6 and a padded liner 7. The plurality of handles 6 is laterally mounted onto the base receptacle 1. Additionally, the plurality of handles 6 is distributed around the base receptacle 1. Thus positioned, the plurality of handles 6 enables the present invention to be easily lifted and transported. The padded liner 7 is mounted within the interior compartment 12 so that the body of the deceased is supported in a desired orientation for viewing and burial. In a supplementary embodiment a locking mechanism is integrated into the interlocking rail assembly 3. This locking mechanism is designed to prevent linear displacement of the lofted lid 2 relative to the base receptacle 1, while engaged. In an alternative embodiment an actuator is integrated into the interlocking rail assembly. Consequently, the lofted lid 2 can be moved by a motorized system.

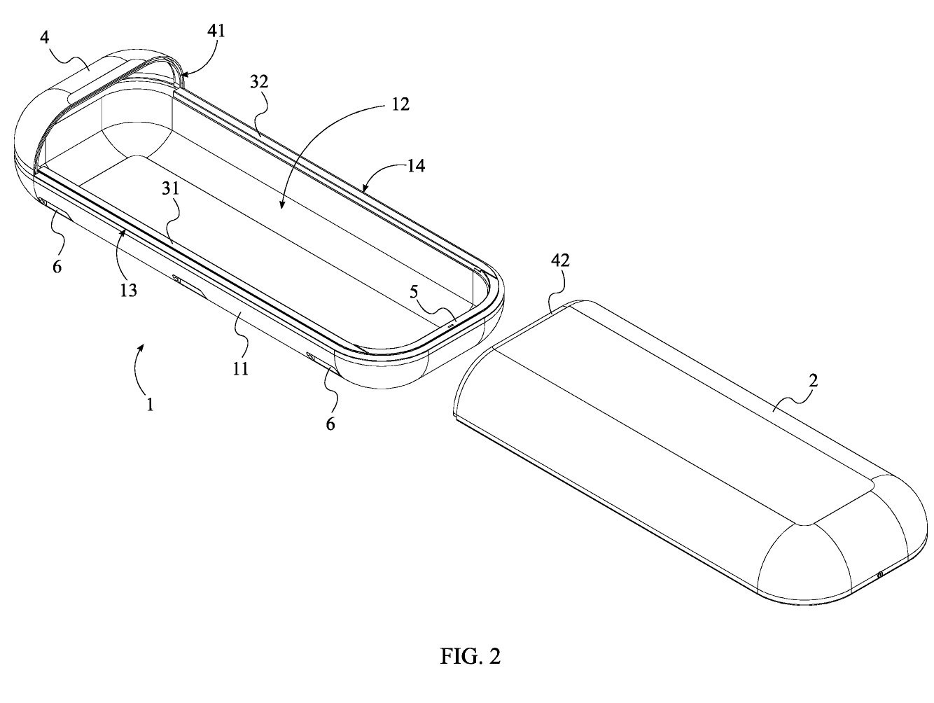

In reference to FIG. 2, as described above, the cap 4 is designed to form a detachable connection between the lofted lid 2 and the base receptacle 1. To facilitate this, the present invention comprises a cap retention groove 41 and a cap support member 42. The cap retention groove 41 laterally traverses into the cap 4. Additionally, the cap retention groove 41 is positioned in between the first lengthwise edge and the second lengthwise edge. As a result, the cap retention groove 41 facilitates the formation of a detachable connection between the cap 4 and the lid. The cap support member 42 is engaged within the cap retention groove 41. Additionally, the cap support member 42 is pressed in between the lofted lid 2 and the cap 4. Thus positioned, the cap support member 42 forms a hermetic seal between the lofted lid 2 and the cap 4 when the lofted lid 2 is positioned over the interior compartment 12.

Although the invention has been explained in relation to its preferred embodiment, it is to be understood that many other possible modifications and variations can be made without departing from the spirit and scope of the invention as hereinafter claimed.

What is claimed is:

1. A burial capsule with an interlocking lid comprising:
a base receptacle;
a lofted lid;
an interlocking rail assembly;
a cap;
the base receptacle comprising a receptacle body and an interior compartment;
the interlocking rail assembly comprising at least one first base rail, at least one second base rail, at least one first lid rail, and at least one second lid rail;
the interior compartment traversing into the receptacle body;
the first base rail being mounted along a first lengthwise edge of the base receptacle;
the second base rail being mounted along a second lengthwise edge of the base receptacle;
the first lid rail being mounted along a first lengthwise edge of the lofted lid;
the second lid rail being mounted along a second lengthwise edge of the lofted lid;
the first lid rail being slidably engaged along the first base rail;
the second lid rail being slidably engaged along the second base rail;
the cap being detachably mounted onto the base receptacle; and
the cap being positioned adjacent to the first base rail and the second base rail.

2. The burial capsule with an interlocking lid as claimed in claim 1 comprising:
the interlocking rail assembly further comprising a base support member and a lid support member;
the base support member and the lid support member each comprising a first leg, a second leg, and an intermediary leg;
the intermediary leg being terminally connected in between the first leg and the second leg;
the base support member being mounted onto a rim of the base receptacle;
the lid support member being mounted onto a rim of the lofted lid;
the first base rail being mounted onto the first leg of the base support member, opposite to the base receptacle;
the second base rail being mounted onto the second leg of the base support member, opposite to the base receptacle;
the first lid rail being mounted onto the first leg of the lid support member, opposite to the lofted lid; and
the second lid rail being mounted onto the second leg of the lid support member, opposite to the lofted lid.

3. The burial capsule with an interlocking lid as claimed in claim 2 comprising:
the base receptacle further comprising a first retention groove;
the first retention groove traversing into the rim of the base receptacle; and
the base support member being engaged within the first retention groove.

4. The burial capsule with an interlocking lid as claimed in claim 2 comprising:
a second retention groove;
the second retention groove traversing into the rim of the lofted lid; and
the lid support member being engaged within the second retention groove.

5. The burial capsule with an interlocking lid as claimed in claim 2 comprising:
the base support member and the lid support member each further comprising an alignment lip;
the alignment lip being mounted onto the intermediary leg; and
the alignment lip being positioned offset from the first leg and the second leg.

6. The burial capsule with an interlocking lid as claimed in claim 1 comprising:
the first base rail and the second base rail each comprising a first rail leg, a second rail leg, and a seal;
the first rail leg of the first base rail being mounted in between the base receptacle and the second rail leg of the first base rail;
the seal of the first base rail being mounted adjacent to the first leg of the first base rail;
the first rail leg of the second base rail being mounted in between the base receptacle and the second rail leg of the second base rail; and
the seal of the second base rail being mounted adjacent to the first leg of the second base rail.

7. The burial capsule with an interlocking lid as claimed in claim 1 comprising:
the first lid rail and the second lid rail each comprising a first rail leg, a second rail leg, and a seal;
the first rail leg of the first lid rail being mounted in between the lofted lid and the second rail leg of the first lid rail;
the seal of the first lid rail being mounted adjacent to the first leg of the first lid rail;
the first lid leg of the second lid rail being mounted in between the lofted lid and the second rail leg of the second lid rail; and
the seal of the second lid rail being mounted adjacent to the first leg of the second lid rail.

8. The burial capsule with an interlocking lid as claimed in claim 1 comprising:
a plurality of handles;
the plurality of handles being laterally mounted onto the base receptacle; and
the plurality of handles being distributed around the base receptacle.

9. The burial capsule with an interlocking lid as claimed in claim 1 comprising:
a padded liner; and
the padded liner being mounted within the interior compartment.

10. The burial capsule with an interlocking lid as claimed in claim 1 comprising:
a cap retention groove;
a cap support member;
the cap retention groove laterally traversing into the cap;
the cap retention groove being positioned in between the first lengthwise edge and the second lengthwise edge;
the cap support member being engaged within the cap retention groove; and
the cap support member being pressed in between the lofted lid and the cap.

11. The burial capsule with an interlocking lid as claimed in claim 1, wherein the cap and the lid hermetically seal the base receptacle.

12. A burial capsule with an interlocking lid comprising:
a base receptacle;
a lofted lid;
an interlocking rail assembly;
a cap;
a plurality of handles;
the base receptacle comprising a receptacle body and an interior compartment;
the interlocking rail assembly comprising at least one first base rail, at least one second base rail, at least one first lid rail, at least one second lid rail, a base support member, and a lid support member;
the interior compartment traversing into the receptacle body;
the first base rail being mounted along a first widthwise edge of the base receptacle;
the second base rail being mounted along a second widthwise edge of the base receptacle;
the first lid rail being mounted along a first widthwise edge of the lofted lid;
the second lid rail being mounted along a second widthwise edge of the lofted lid;
the first lid rail being slidably engaged along the first base rail;
the second lid rail being slidably engaged along the second base rail;
the cap being detachably mounted onto the base receptacle;
the cap being positioned adjacent to the first base rail and the second base rail;
the base support member and the lid support member each comprising a first leg, a second leg, and an intermediary leg;
the intermediary leg being terminally connected in between the first leg and the second leg;
the base support member being mounted onto a rim of the base receptacle;
the lid support member being mounted onto a rim of the lofted lid;
the first base rail being mounted onto the first leg of the base support member, opposite to the base receptacle;
the second base rail being mounted onto the second leg of the base support member, opposite to the base receptacle;
the first lid rail being mounted onto the first leg of the lid support member, opposite to the lofted lid;
the second lid rail being mounted onto the second leg of the lid support member, opposite to the lofted lid;
the plurality of handles being laterally mounted onto the base receptacle; and
the plurality of handles being distributed around the base receptacle.

13. The burial capsule with an interlocking lid as claimed in claim 12 comprising:
the base receptacle further comprising a first retention groove;
the first retention groove traversing into the rim of the base receptacle; and
the base support member being engaged within the first retention groove.

14. The burial capsule with an interlocking lid as claimed in claim 12 comprising:
a second retention groove;
the second retention groove traversing into the rim of the lofted lid; and
the lid support member being engaged within the second retention groove.

15. The burial capsule with an interlocking lid as claimed in claim 12 comprising:
the base support member and the lid support member each further comprising an alignment lip;
the alignment lip being mounted onto the intermediary leg; and
the alignment lip being positioned offset from the first leg and the second leg.

16. The burial capsule with an interlocking lid as claimed in claim 12 comprising:
the first base rail and the second base rail each comprising a first rail leg, a second rail leg, and a seal;
the first rail leg of the first base rail being mounted in between the base receptacle and the second rail leg of the first base rail;
the seal of the first base rail being mounted adjacent to the first leg of the first base rail;
the first rail leg of the second base rail being mounted in between the base receptacle and the second rail leg of the second base rail; and
the seal of the second base rail being mounted adjacent to the first leg of the second base rail.

17. The burial capsule with an interlocking lid as claimed in claim 12 comprising:
the first lid rail and the second lid rail each comprising a first rail leg, a second rail leg, and a seal;
the first rail leg of the first lid rail being mounted in between the lofted lid and the second rail leg of the first lid rail;
the seal of the first lid rail being mounted adjacent to the first leg of the first lid rail;
the first lid leg of the second lid rail being mounted in between the lofted lid and the second rail leg of the second lid rail; and
the seal of the second lid rail being mounted adjacent to the first leg of the second lid rail.

18. The burial capsule with an interlocking lid as claimed in claim 12 comprising:
a padded liner; and
the padded liner being mounted within the interior compartment.

19. The burial capsule with an interlocking lid as claimed in claim 12 comprising:
a cap retention groove;
a cap support member;
the cap retention groove laterally traversing into the cap;
the cap retention groove being positioned in between the first lengthwise edge and the second lengthwise edge;
the cap support member being engaged within the cap retention groove; and
the cap support member being pressed in between the lofted lid and the cap.

20. The burial capsule with an interlocking lid as claimed in claim 12, wherein the cap and the lid hermetically seal the base receptacle.
